(19) United States
(12) Patent Application Publication
(10) Pub. No.: US 2012/0147586 A1
(43) Pub. Date: Jun. 14, 2012

(54) LED MODULE AND LAMP HAVING THE SAME

(76) Inventors: Shang-Bin Li, George Town (KY); Zheng-Fei Xu, George Town (KY); Yong Chen, George Town (KY); Richard T. Wang, George Town (KY)

(21) Appl. No.: 12/966,226

(22) Filed: Dec. 13, 2010

(51) Int. Cl. F21V 9/16; H01J 1/62

(52) U.S. Cl. 362/84; 313/483

(57) ABSTRACT

The present invention relates a LED module and a lamp having the same. The LED module includes a substrate, a reflector, a transparent shroud and a fluorescent gel layer. The substrate has an accommodating portion in which at least one LED chip is received. The reflector is provided on the substrate and has an accommodating space in which a first gel is received. The transparent shroud is connected to the reflector to seal the first gel. The fluorescent gel layer is provided between the transparent shroud and the first gel. With this structure, light spot and color temperature of the emitted light become more uniform, and the light-emitting efficiency thereof is improved greatly.

### BACKGROUND OF THE INVENTION

1. Field of the Invention

The present invention relates to a LED module and a lamp having the same, and in particular to a LED module and a lamp having the same, wherein light spot and color temperature of the emitted light become more uniform, and the light-emitting efficiency thereof is improved greatly.

2. Description of Prior Art

With the rapid development of light emitting diodes (LED), the light-emitting efficiency of the LED has exceeded that of traditional light sources, so that a large-power LED lamp has been widely used in indoor and outdoor lighting.

The existing LED lamp is constituted of tens or hundreds of 1-watt LEDs to form a LED module, thereby achieving a desired luminous flux and luminance. However, such a LED module has a comparatively large size. If such a large-sized LED module is used to illuminate an object within a short distance, these LEDs will generate a plurality of shadows because the light is obstructed by the object (person or article) in the illumination range. In order to solve this problem, the manufacturers in this art propose an improved LED module constituted by a plurality of large-power LED chips, whereby only one LED module can generate a power of 50 watts or 100 watts and the shadow problem can be overcome. However, such a large-power LED module has a thermal power density much larger than that of a LED package constituted of one LED chip. Further, the temperature of a central heat spot may affect the light-emitting efficiency and lifetime of fluorescent powders coated on the LED chip. As a result, the light generated by the LED module is decayed.

Thus, in order to overcome the above-mentioned problems, the manufacturers in this field propose a light emitting diode structure. As shown in FIG. 1, the light emitting diode structure 1 includes a fluorescent powder layer 10, a blue LED module 11, a lens 12, a substrate 13 and a reflector 14. The fluorescent powder layer 10 is formed on the lens 12 and is constituted of fluorescent powders 101. The blue module 11 is constituted of a plurality of blue LEDs 111 of 1 watt or lower watt for serving as a light source. The blue LED module 11 is provided on the substrate 13. One end of the reflector 14 is connected to the substrate 13 to face the blue LED module 11. The other end of the reflector 14 is connected to the lens 12. With this arrangement, the light emitting diode structure 1 is formed. Thus, when the blue LED module 11 emits light, the reflector 14 reflects the light toward the lens 12, thereby increasing the light-emitting efficiency thereof.

However, in practice, the light-emitting efficiency of the LED module 11 is so limited that a large portion of the visible light emitted by the blue LED 111 may be reflected by the fluorescent powder layer 10 to the interior of the LED module 11. As a result, the light-emitting efficiency of the LED module 11 is deteriorated. Further, the light is reflected by the reflector 14 for several times, which causes further loss of light.

Further, since each blue LED of the blue LED module 11 is large in size, the blue LED module 11 has a large surface area for absorbing the light, which affects the penetration of light and reduces the light-emitting effect.

Therefore, the prior art has the following disadvantages:

(1) the light-emitting efficiency is poor;

(2) light spot and color temperature of the emitted light are bad; and

(3) the light is decayed due to the high temperature.

In view of the above, the present inventor proposes a novel structure based on his expert experience and delicate researches.

### SUMMARY OF THE INVENTION

In order to solve the above problems, a primary objective of the present invention is to provide a LED module having an improved light-emitting efficiency.

A secondary objective of the present invention is to provide a LED module, in which light spot and color temperature become more uniform.

A third objective of the present invention is to provide a LED module, in which the light decay is prevented.

A fourth objective of the present invention is to provide a lamp with an increased light-emitting efficiency as well as more uniform light spot and color temperature.

In order to achieve the above objectives, the present invention provides a lamp, including:

a reflector having an accommodating space and an opening in communication with the accommodating space, a first gel being received in the accommodating space;

a transparent shroud connected to the reflector to seal the first gel, the transparent shroud being combined with the reflector to form one body; and

a fluorescent gel layer provided between the transparent shroud and the first gel, the fluorescent gel layer being provided therein with a fluorescent powder and a second gel, the fluorescent powder being covered within the second gel.

By this structure, light decay is prevented, light spot and color temperature become more uniform, and the light-emitting efficiency of the lamp is increased.

The present invention further provides a LED module, including:

a substrate having an accommodating portion for allowing at least one LED chip to be received therein;

a reflector provided on the substrate to correspond to the LED chip, the reflector having an accommodating space in communication with the accommodating portion, a first gel being received in the accommodating space;

a transparent shroud connected to the reflector to seal the first gel, the transparent shroud being combined with the reflector to form one body; and

a fluorescent gel layer provided between the transparent shroud and the first gel, the fluorescent gel layer being provided therein with a fluorescent powder and a second gel, the fluorescent powder being covered within the second gel.

By this structure, the substrate, the reflector, the transparent shroud and the fluorescent gel layer are combined together to form one body, so that light decay is prevented, light spot and color temperature become more uniform, and the light-emitting efficiency of the LED module is increased.

### BRIEF DESCRIPTION OF THE DRAWINGS

FIG. 1 is an assembled cross-sectional view of prior art;

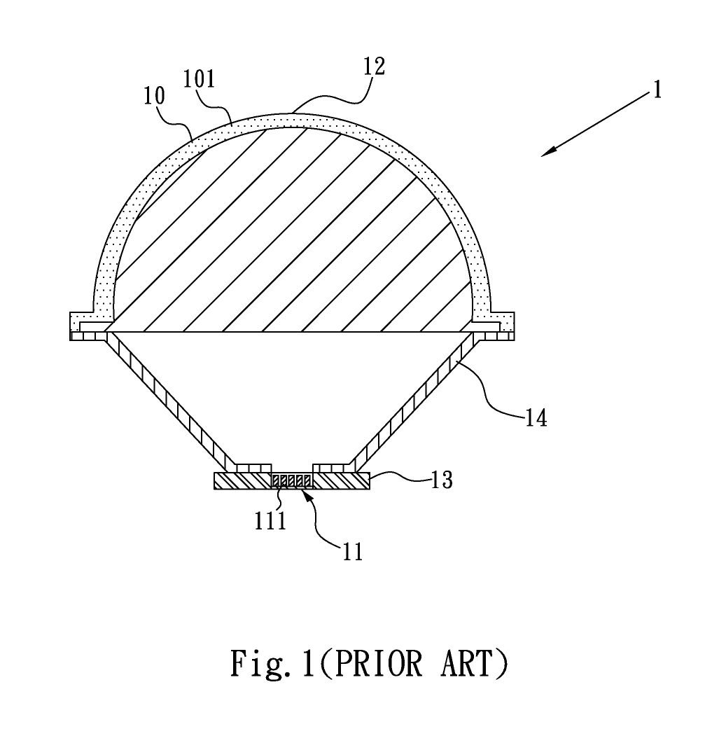

FIG. 2A is an assembled cross-sectional view showing a LED module according to the first embodiment of the present invention;

FIG. 2B is an exploded cross-sectional view showing the LED module according to the first embodiment of the present invention;

FIG. 3 is an assembled cross-sectional view showing the LED module according to the second embodiment of the present invention;

FIG. 4 is an assembled cross-sectional view showing the LED module according to the third embodiment of the present invention;

FIG. 5 is an assembled cross-sectional view showing the LED module according to the fourth embodiment of the present invention;

FIG. 6 is an assembled cross-sectional view showing the LED module according to the fifth embodiment of the present invention;

FIG. 7 is an assembled cross-sectional view showing the LED module according to the sixth embodiment of the present invention;

FIG. 8A is an assembled cross-sectional view showing the lamp according to the seventh embodiment of the present invention;

FIG. 8B is an exploded cross-sectional view showing the lamp according to the seventh embodiment of the present invention;

FIG. 9 is an assembled cross-sectional view showing the lamp according to the eighth embodiment of the present invention;

FIG. 10 is an assembled cross-sectional view showing the lamp according to the ninth embodiment of the present invention;

FIG. 11 is an assembled cross-sectional view showing the lamp according to the tenth embodiment of the present invention;

FIG. 12 is an assembled cross-sectional view showing the lamp according to the eleventh embodiment of the present invention; and

FIG. 13 is an assembled cross-sectional view showing the lamp according to the twelfth embodiment of the present invention.

### DETAILED DESCRIPTION OF THE INVENTION

The above objectives and structural and functional features of the present invention will be described in more detail with reference to preferred embodiments thereof shown in the accompanying drawings

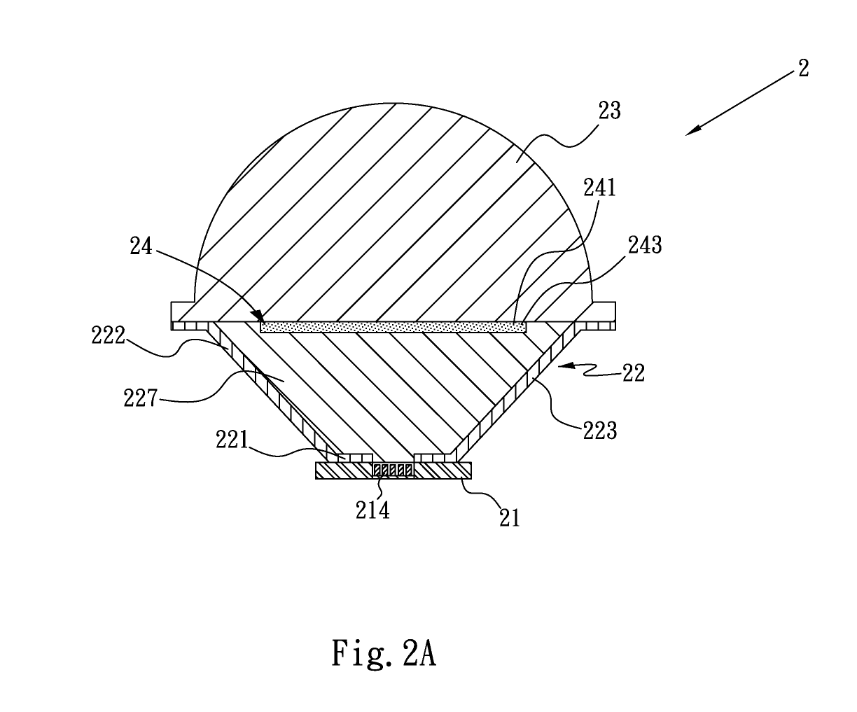

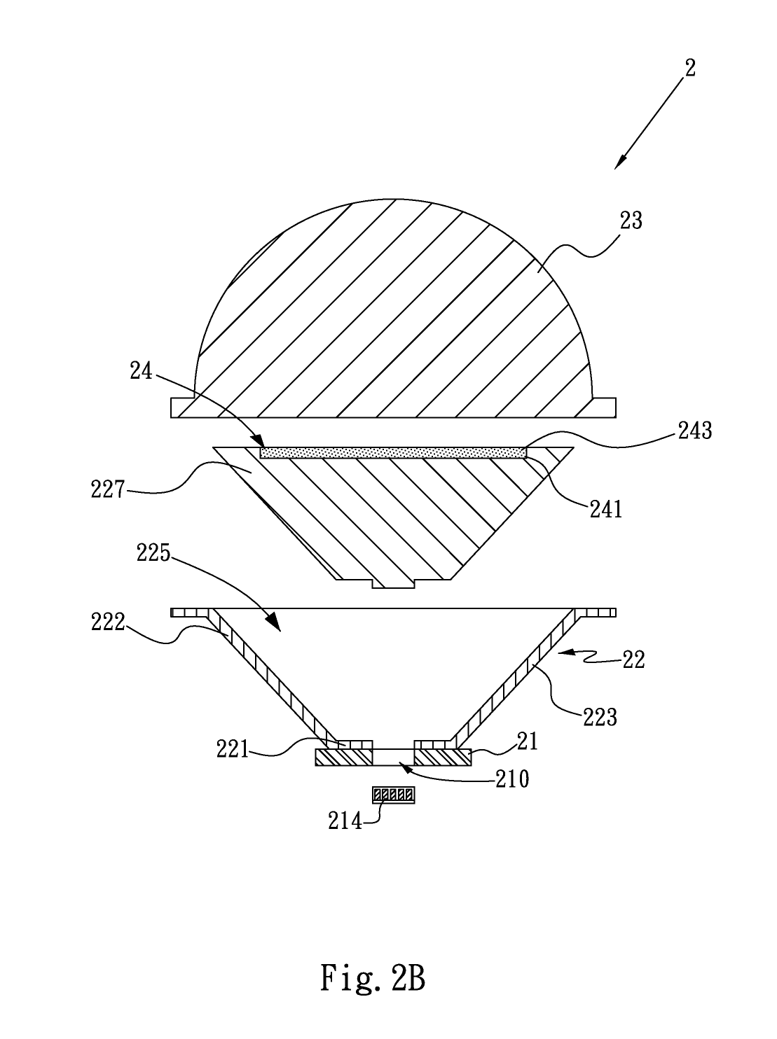

Please refer to FIGS. 2A and 2B. The present invention provides a LED module 2. In the first embodiment of the present invention, the LED module 2 includes a substrate 21, a reflector 22, a transparent shroud 23 and a fluorescent gel layer 24. The substrate 21 is made of a material selected from a group including copper, aluminum, ceramics, graphite and silicon. In a preferred embodiment, the substrate 21 is made of copper. The substrate 21 has an accommodating portion 210 for allowing at least one LED chip 214 to be received therein. The LED chip 214 may be a GaN LED chip or an InGaN LED chip.

The reflector 22 is made of a Micro Cellular PET (MCPET) reflection panel. The reflector 22 is provided on the substrate 21 to correspond to the LED chip 214 for reflecting the light emitted by the LED chip 214. The reflector 22 further has a base 221, a first reflecting portion 222, a second reflection portion 223, and an accommodating space 225 in communication with the accommodating portion 210. A first gel 227 is received in the accommodating space 225. The first gel 227 is silica gel whose hardness is equal to or smaller than 30 Shore A. The silica gel can achieve high light transmittance and transparency of visible light, reduce the change in the refraction index along the travelling path of light, diminish the light loss in the LED module 2, and increase the light-emitting efficiency due to its properties.

The first gel 227 is capable of lowering the temperature of the fluorescent gel layer 24, so that the LED module 2 can be kept in a stable temperature to abate the color temperature drift when the power of the LED module 2 is adjusted. In comparison with the conventional LED module in which the fluorescent powder layer and the LED chip are packaged together, the temperature of the conventional LED module varies with the magnitude of power, and the temperature of the fluorescent powders also changes, so that the change in the temperature of fluorescent powders results in the change in the excitation efficiency and the down-conversion to cause the color temperature drift.

The base 221 is connected on the substrate 21 above the LED chips 214. The first reflecting portion 222 and the second reflecting portion 223 are formed by extending outwards from both sides of the base 221 respectively. The first reflecting portion 222 and the second reflecting portion 223 together define the accommodating space 225. That is, the first reflecting portion 222 and the second reflecting portion 223 are formed by extending from both sides of the base 221 in an inclined and symmetrical manner, so that both of them can define the accommodating space 225.

Please refer to FIG. 2A again. The transparent shroud 23 is any one selected from a group including a glass lens, a convex lens, a concave lens, a Fresnel lens, and a composite lens constituted of a plurality of lenses. In a preferred embodiment, the transparent shroud 23 is a convex lens, but it is not limited thereto. The transparent shroud 23 is connected to the reflector 22 to seal the first gel 227, so that the transparent shroud 23, the reflector 22 and the substrate 21 are combined into one unit to form the LED module 2. The refraction index of the transparent shroud 23 is smaller than that of the first gel 227.

The fluorescent gel layer 24 is provided between the transparent shroud 23 and the first gel 227. That is, the fluorescent gel layer 24 is formed in one end of the first gel 227 adjacent to the transparent shroud 23. One side of the fluorescent gel layer 24 facing the LED chip 214 is a light-entering surface. A fluorescent powder 241 and a second gel 243 are doped in the fluorescent gel layer 24. The fluorescent powder 241 is covered within the second gel 243. In this way, a distance between the fluorescent gel layer 24 and the LED chips 214 is equal to or larger than 2 mm, so that the blue light emitted by the LED chips 214 can illuminate the fluorescent powder 241 uniformly. That is, the blue light and another light red-shifted by the down-conversion of the fluorescent powder 241 can be mixed together more sufficiently at respective angles, so that the light penetrating through the transparent shroud 23 will not generate any real image or virtual image. Thus, the color and angles of the light emitted by the LED module 2 of the present invention can be distributed more uniformly.

The second gel 243 is a transparent silica gel or a transparent oil ink. In a preferred embodiment, the second gel 243 is silica gel. The refraction index of the transparent silica gel is in a range from 1.5 to 1.54. Further, the thickness of the fluorescent gel layer 24 is smaller than 1 mm. This thickness is not a constant but a convex function h(X, Y) in a X-Y coordinate system by using a light-exiting surface of the LED chip 214 as a reference surface, in which “h” is the thickness of the fluorescent gel layer 24. The convex function is in direct proportion to the illumination distribution function generated by the LED module 2 where the fluorescent gel layer 24 is located. The weight ratio between the fluorescent powder 241 and the transparent silica gel is in a range from 1:8 to 1:2.

Thus, when the LED module 2 emits visible light, the light passes through the first gel 227 and the fluorescent gel layer 24. Then, the first gel 227 and the second gel 243 enhance the light-emitting efficiency. At the same time, a portion of the light is reflected by the reflector 22 toward the second gel 243 and the transparent shroud 23. Finally, the light penetrates the transparent shroud 23 to project to the outside. Thus, when the LED module 2 of the present invention illuminates an object from a short or long distance, the problem of multiple shadows will not occur, and the color of light will not vary within the illumination range. Thus, according to the present invention, the light spot and the color temperature become more uniform, and the light-emitting efficiency of the present invention is improved greatly.

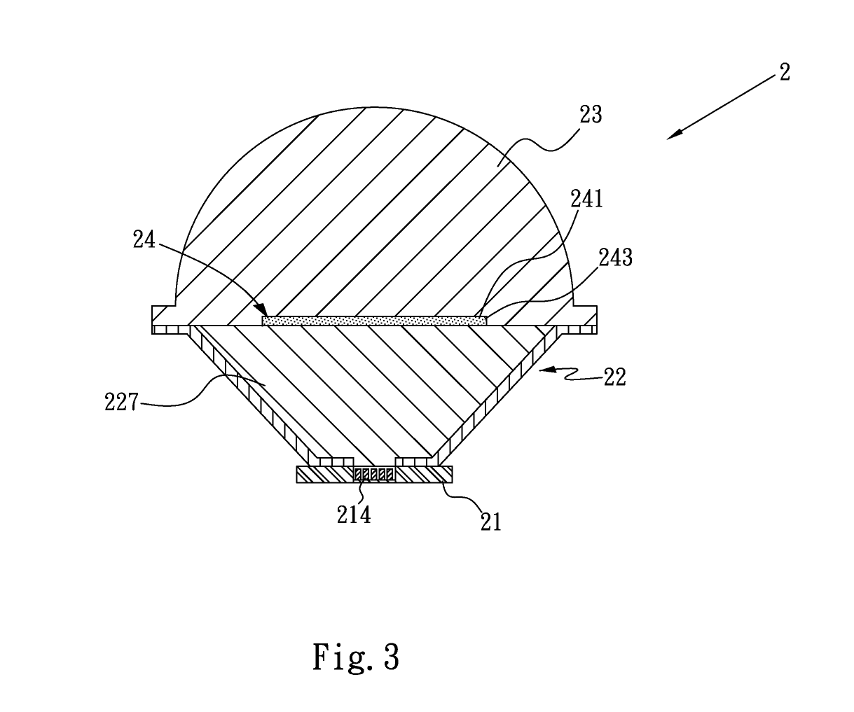

Please refer to FIG. 3 showing the second embodiment of the present invention. The second embodiment is substantially the same as the first embodiment. The difference between the second embodiment and the first embodiment lies in that: the fluorescent gel layer 24 is formed in the transparent shroud 23 adjacent to the first gel 227. The second gel 243 is transparent silica gel or oil ink. In the preferred embodiment, the transparent silica gel is used as an example.

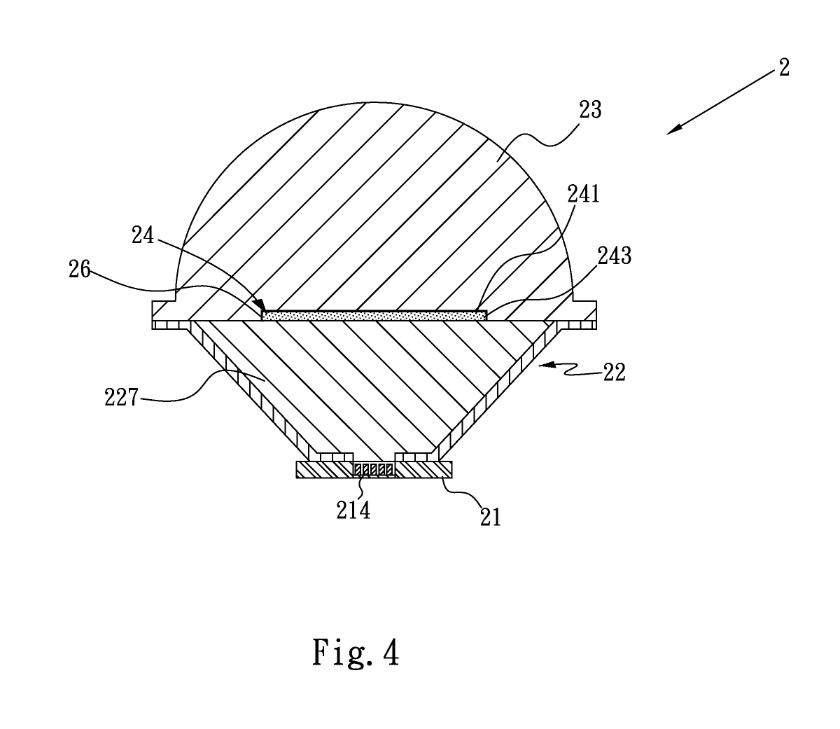

Please refer to FIG. 4 showing the third embodiment of the present invention. The third embodiment is substantially the same as the second embodiment. The difference between the third embodiment and the second embodiment lies in that: a rugged surface 26 is provided between the transparent shroud 23 and the fluorescent gel layer 24. The rugged surface 26 is formed on an outer surface of the fluorescent gel layer 24 which is not brought into contact with the first gel 227.

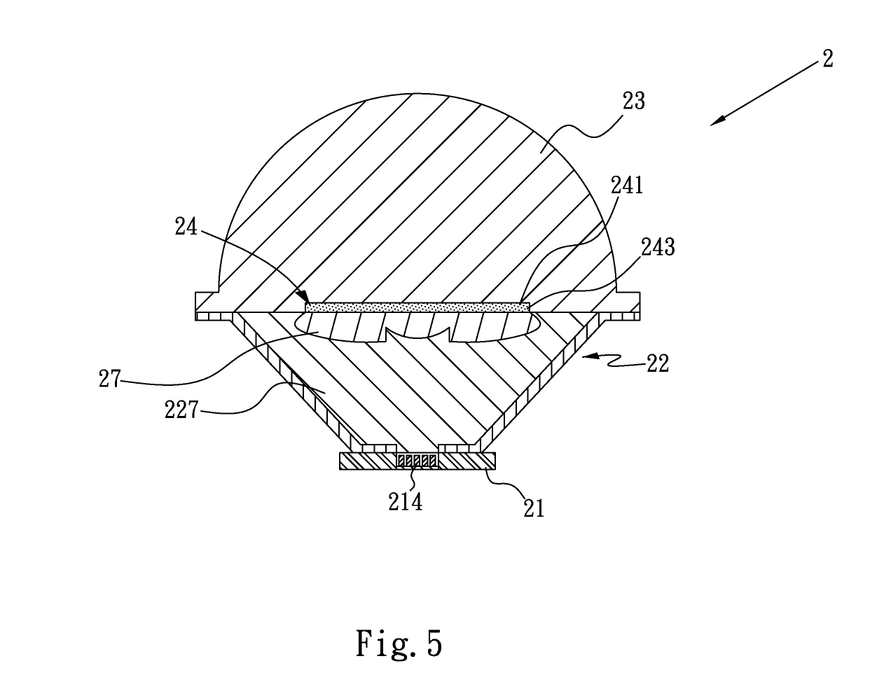

Please refer to FIG. 5 showing the fourth embodiment of the present invention. The fourth embodiment is substantially the same as the second embodiment. The difference between the fourth embodiment and the second embodiment lies in that: the LED module 2 further comprises a lens 27. The lens 27 is connected to the bottom of the transparent shroud 23 and covered within one end of the first gel 227 adjacent to the fluorescent gel layer 24. Another fluorescent powder is filled in the lens 27. The lens 27 is any one selected from a group including a glass lens, a convex lens, a concave lens, a Fresnel lens, and a composite lens constituted of a plurality of lenses.

The light-emitting efficiency of the lens 27 and the transparent shroud 23 can be preset according to practical demands. As shown in FIG. 5, the lens 27 is a Fresnel lens and the transparent lens 23 is a convex lens, thereby generating a different light-emitting efficiency.

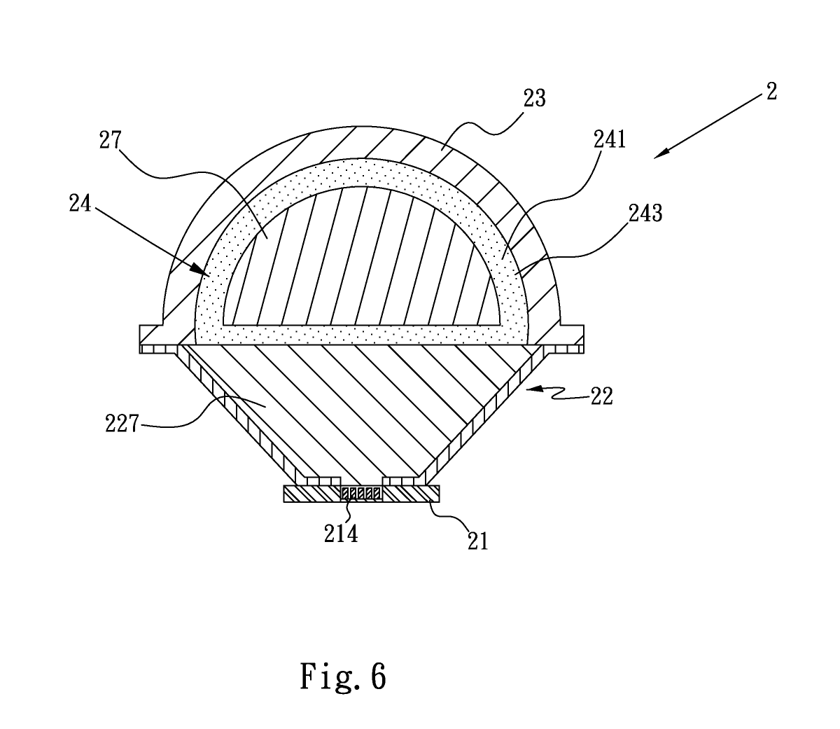

Please refer to FIG. 6 showing the fifth embodiment of the present invention. The fifth embodiment is substantially the same as the second embodiment. The difference between the fifth embodiment and the second embodiment lies in that: the LED module 2 further includes at least one lens 27 provided in the fluorescent gel layer 24. The fluorescent gel layer 24 is formed to cover outside the lens 27, so that the fluorescent gel layer 24 serves as a light-entering surface. In a preferred embodiment, the user can adjust the numbers of the lenses 27 and the fluorescent gel layers 24 in the transparent shroud 23 according to the demands for the desired light-emitting efficiency. For example, two lenses 27 are inserted into the transparent shroud 23 to form a composite lens, and the fluorescent gel layers 24 are filled between the two lenses 27 as well as the transparent shroud 23 and one of the lens 27. The contact area between the fluorescent gel layer 24 and the lens 27 is larger than or equal to the illuminated area of the transparent shroud 23.

The lens 27 is any one selected from a group including a glass lens, a convex lens, a concave lens, a Fresnel lens and a composite lens constituted of a plurality of lenses. The lens 27 and the transparent shroud 23 can be suitably selected to generate a desired light-emitting efficiency. For example, as shown in FIG. 6, the lens 27 is a convex lens, and the transparent shroud 23 is a convex lens, thereby generating a different light-emitting efficiency.

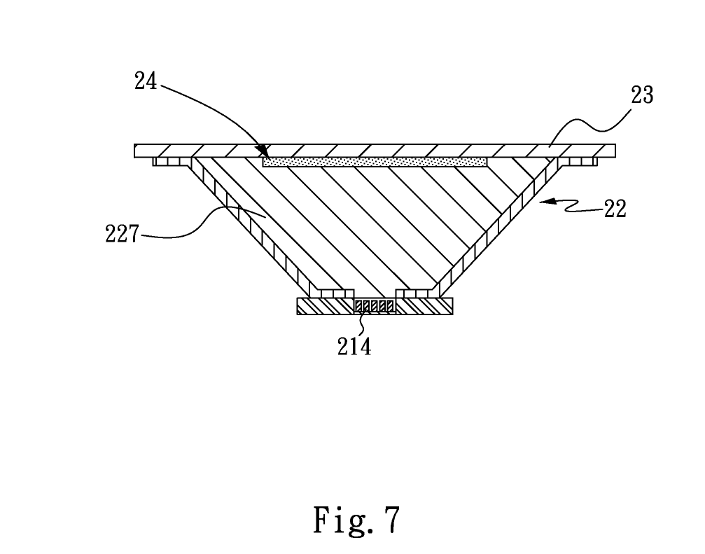

Please refer to FIG. 7 showing the sixth embodiment of the present invention. The sixth embodiment is substantially the same as the first embodiment. The difference between the sixth embodiment and the first embodiment lies in that: the transparent shroud 23 in the first embodiment is a convex lens, while the transparent shroud 23 in the present embodiment is a flat glass lens and the transparent shroud 23 in the present embodiment is also a flat glass lens, thereby generating a different design.

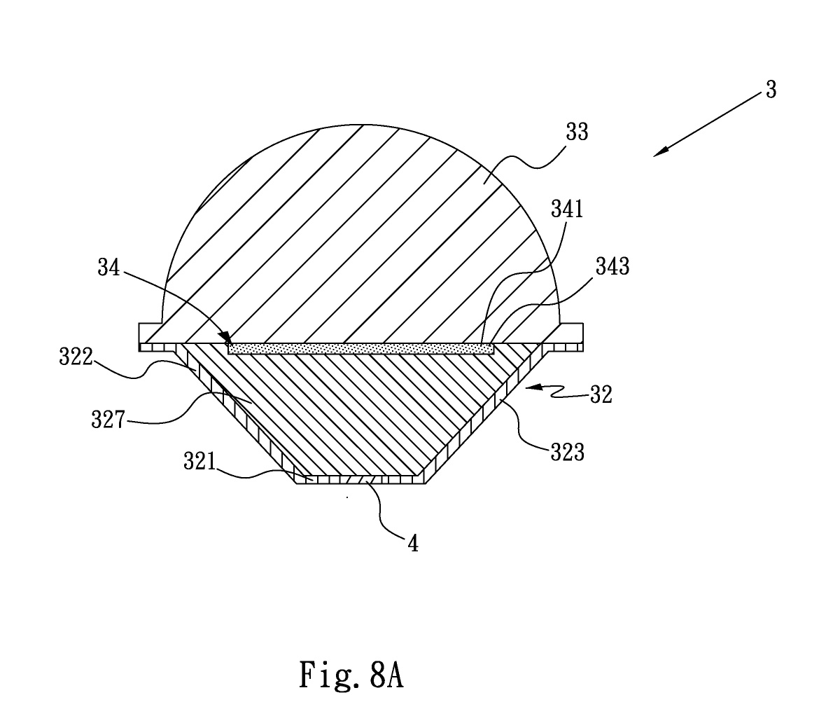

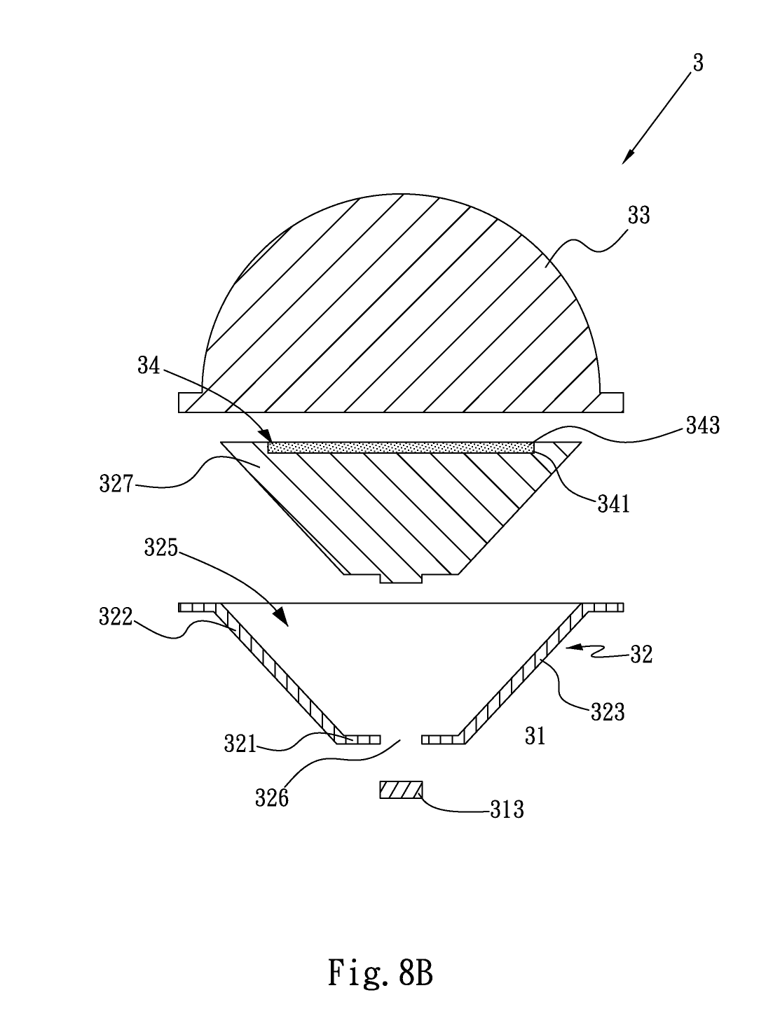

Please refer to FIGS. 8A and 8B, which are assembled cross-sectional views showing the lamp according to the seventh embodiment of the present invention The lamp 3 includes a reflector 32, a transparent shroud 33 and a fluorescent gel layer 34. The reflector 32 is made of a Micro Cellular PET (MCPET) reflection panel for reflecting the light emitted by a LED module 4. The reflector 32 has a base 321, a first reflecting portion 322, a second reflecting portion 323, an accommodating space 325 and an opening 326 in communication with the accommodating space 325. The opening 326 is formed through the base 321. The LED module 4 is received in the opening 326. The LED module 4 may be a blue LED module mentioned in the above embodiments or the LED modules of other colors.

Please refer to FIG. 8B again. The first reflecting portion 322 and the second reflecting portion 323 are formed by extending outwards from both sides of the base 321. The first reflecting portion 322 and the second reflecting portion 323 together define the accommodating space 325. That is, the first reflecting portion 32 and the second reflecting portion 33 are formed by extending from both sides of the base 32 in an inclined and symmetrical manner, so that both of them define the accommodating space 35.

A first gel 37 is received in the accommodating space 325. The first gel 37 is silica gel whose hardness is equal to or smaller than 30 Shore A. The silica gel can achieve high light transmittance and transparency of visible light, reduce the change in the refraction index along the travelling path of light, diminish the light loss in the LED module 2, and increase the light-emitting efficiency due to its properties.

The first gel 327 is capable of lowering the temperature of the fluorescent gel layer 34, so that the LED module 4 can be kept in a stable temperature to abate the color temperature drift when the power of the LED module 2 is adjusted. In comparison with the conventional LED module in which the fluorescent powder layer and the LED chip are packaged together, the temperature of the conventional LED module varies with the magnitude of power, and the temperature of the fluorescent powders also changes. As a result, the change in the temperature of fluorescent powders results in the change in the excitation efficiency and the down-conversion to cause the color temperature drift.

The transparent shroud 33 is any one selected from a group including a glass lens, a convex lens, a concave lens, a Fresnel lens, and a composite lens constituted of a plurality of lenses. In a preferred embodiment, the transparent shroud 33 is a convex lens, but it is not limited thereto. The transparent shroud 33 is connected to the reflector 32 to seal the first gel 327, so that the transparent shroud 33 and the reflector 32 are combined into one unit to form the LED module 4. The refraction index of the transparent shroud 33 is smaller than that of the first gel 327.

Please refer to FIGS. 8A and 8B again. The fluorescent gel layer 34 is provided between the transparent shroud 33 and the first gel 327. That is, the fluorescent gel layer 34 is formed in one end of the first gel 327 adjacent to the transparent shroud 33. One side of the fluorescent gel layer 34 facing the LED module 4 is a light-entering surface. A fluorescent powder 341 and a second gel 343 are doped in the fluorescent gel layer 34. The fluorescent powder 341 is covered within the second gel 343. In this way, a distance between the fluorescent gel layer 34 and the LED module 4 is equal to or larger than 2 mm, so that the blue light emitted by the LED module 4 can illuminate the fluorescent powder 341 uniformly. That is, the blue light and another light red-shifted by the down-conversion of the fluorescent powder 241 can be mixed together more sufficiently at respective angles, so that the light penetrating through the transparent shroud 33 will not generate any real image or virtual image. Thus, the light emitted by the lamp of the present invention can achieve a more uniform distribution of in terms of color and angle. The second gel 343 is transparent silica gel, but it is not limited thereto. The second gel 343 may be transparent oil ink. The refraction index of the transparent silica gel is in a range from 1.5 to 1.54. Further, the thickness of the fluorescent gel layer 34 is smaller than 1 mm. This thickness is not a constant but a convex function h(X, Y) in a X-Y coordinate system by using a light-exiting surface of the LED module 4 as a reference surface, in which “h” is the thickness of the fluorescent gel layer 34. The convex function is in direct proportion to the illumination distribution function generated by the LED module 4 where the fluorescent gel layer 34 is located. The weight ratio between the fluorescent powder 341 and the transparent silica gel is in a range from 1:8 to 1:2.

Thus, when the LED module 4 emits visible light, the light passes through the first gel 327 and the fluorescent gel layer 34. Then, the first gel 327 and the second gel 343 enhance the light-emitting efficiency. At the same time, a portion of the light is reflected by the reflector 32 toward the second gel 343 and the transparent shroud 33. Finally, the light penetrates the transparent shroud 33 to project to the outside. Thus, when the lamp 3 of the present invention illuminates an object from a short or long distance, the problem of multiple shadows will not occur, and the color of light will not vary within the illumination range. Thus, according to the present invention, the light spot and the color temperature become more uniform, and the light-emitting efficiency of the present invention is improved greatly.

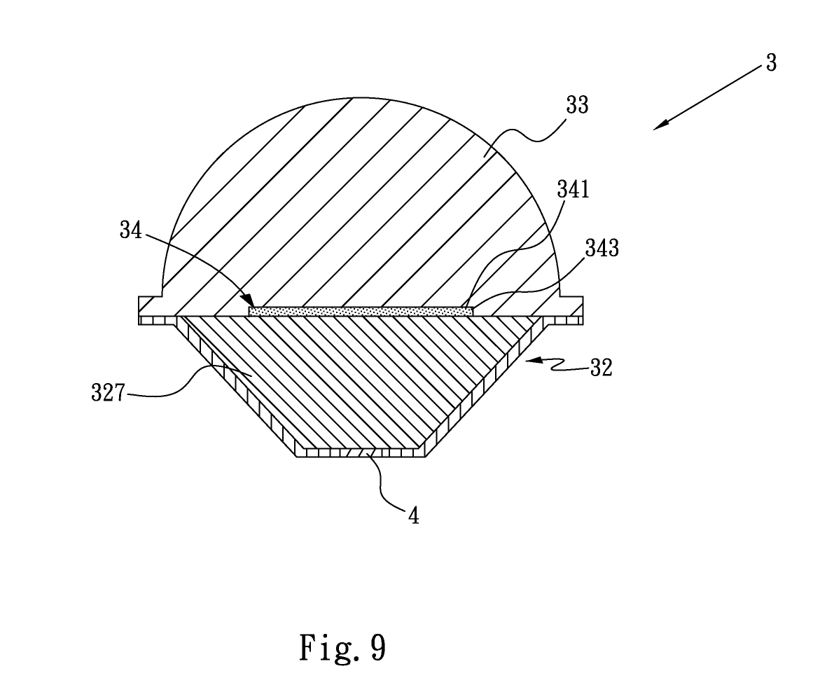

Please refer to FIG. 9, which is an assembled cross-sectional view showing the lamp according to the eighth embodiment of the present invention. The eighth embodiment is substantially the same as the seventh embodiment. The difference between the eighth embodiment and the seventh embodiment lies in that: the fluorescent gel layer 34 is formed in the transparent shroud 33 adjacent to the first gel 327. The second gel 343 is transparent silica gel or oil ink. In the preferred embodiment, the transparent silica gel is used as an example.

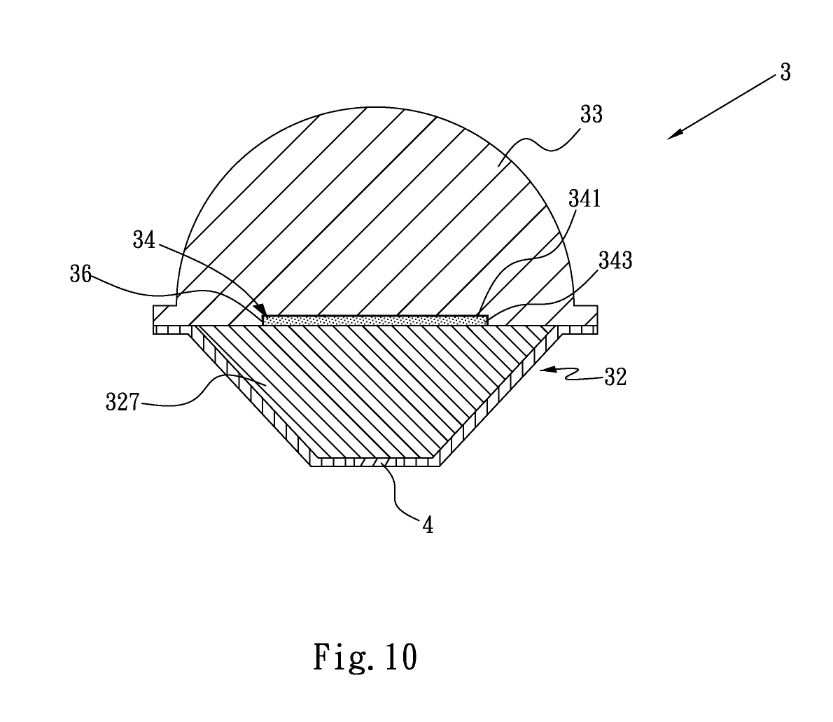

Please refer to FIG. 10, which is an assembled cross-sectional view showing the lamp according to the ninth embodiment of the present invention. The ninth embodiment is substantially the same as the eighth embodiment. The difference between the ninth embodiment and the eighth embodiment lies in that: a rugged surface 36 is provided between the transparent shroud 33 and the fluorescent gel layer 34. The rugged surface 36 is formed on an outer surface of the fluorescent gel layer 34 which is not brought into contact with the first gel 327.

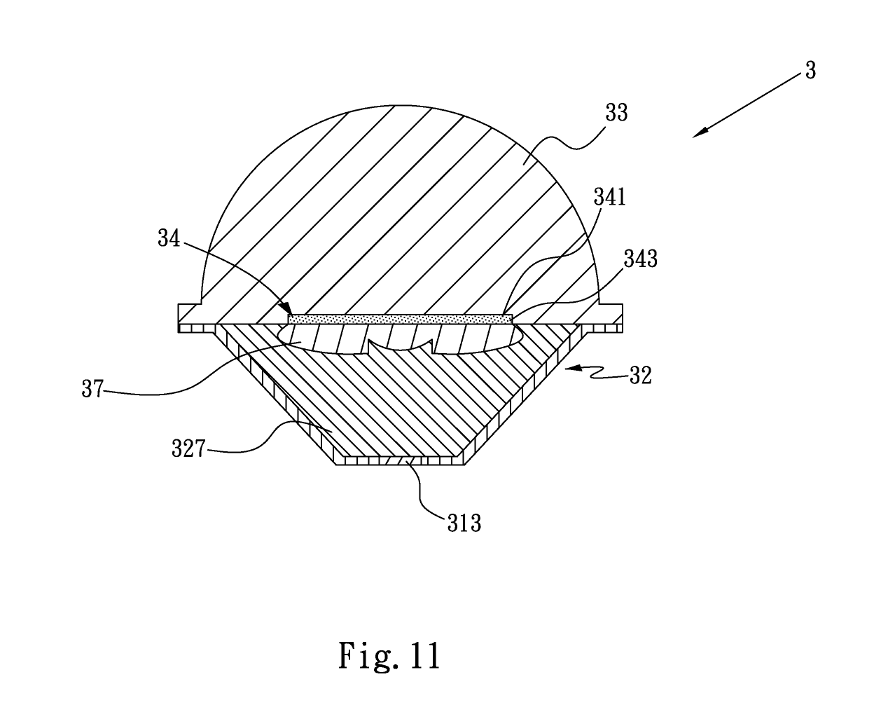

Please refer to FIG. 11, which is an assembled cross-sectional view showing the lamp according to the tenth embodiment of the present invention. The tenth embodiment is substantially the same as the eighth embodiment. The difference between the tenth embodiment and the eighth embodiment lies in that: the lamp 3 further comprises a lens 37. The lens 37 is connected to the bottom of the transparent shroud 33 and covered within one end of the first gel 327 adjacent to the fluorescent gel layer 34. Another fluorescent powder is filled in the lens 37. The lens 37 is any one selected from a group including a glass lens, a convex lens, a concave lens, a Fresnel lens, and a composite lens constituted of a plurality of lenses.

The light-emitting efficiency of the lens 37 and the transparent shroud 33 can be preset based on practical demands. As shown in FIG. 11, the lens 37 is a Fresnel lens and the transparent lens 33 is a convex lens, thereby generating a different light-emitting efficiency.

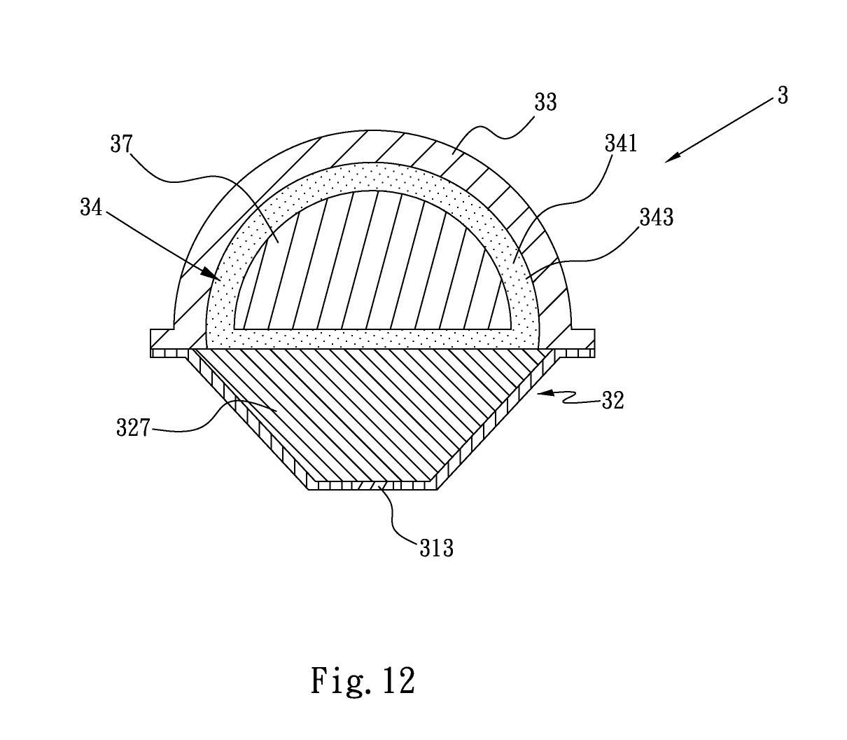

Please refer to FIG. 12, which is an assembled cross-sectional view showing the lamp according to the eleventh embodiment of the present invention. The eleventh embodiment is substantially the same as the eighth embodiment. The difference between the eleventh embodiment and the eighth embodiment lies in that: the lamp 3 further includes at least one lens 37 provided in the fluorescent gel layer 34. The fluorescent gel layer 34 is formed to cover outside the lens 37, so that the fluorescent gel layer 34 serves as a light-entering surface. In a preferred embodiment, the user can adjust the numbers of the lenses 37 and the fluorescent gel layers 34 in the transparent shroud 33 according to the demands for the desired light-emitting efficiency. For example, two lenses 37 are inserted into the transparent shroud 33 to form a composite lens, and the fluorescent gel layers 34 are filled between the two lenses 37 as well as the transparent shroud 33 and one of the lenses 27. The contact area between the fluorescent gel layer 34 and the lens 37 is larger than or equal to the illuminated area of the transparent shroud 33.

The lens 37 is any one selected from a group including a glass lens, a convex lens, a concave lens, a Fresnel lens and a composite lens constituted of a plurality of lenses. The lens 37 and the transparent shroud 33 can be suitably selected to generate a desired light-emitting efficiency. For example, as shown in FIG. 12, the lens 37 is a convex lens, and the transparent shroud 33 is a convex lens, thereby generating a different light-emitting efficiency.

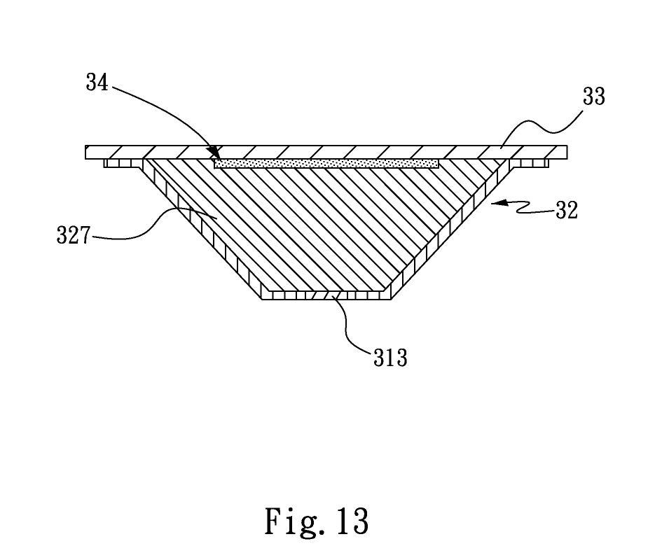

Please refer to FIG. 13, which is an assembled cross-sectional view showing the lamp according to the twelfth embodiment of the present invention. The twelfth embodiment is substantially the same as the seventh embodiment. The difference between the twelfth embodiment and the seventh embodiment lies in that: the transparent shroud 33 in the seventh embodiment is a convex lens, while the transparent shroud 33 in the present embodiment is a flat glass lens and the transparent shroud 33 in the present embodiment is also a flat glass lens, thereby generating a different design.

According to the above, in comparison with prior art, the present invention has the following advantages:

(1) the light-emitting efficiency is increased;

(2) the light spot and the color temperature become more uniform; and

(3) the light decay is prevented.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A lamp, including:
a reflector having an accommodating space and an opening in communication with the accommodating space, a first gel being received in the accommodating space;
a transparent shroud connected to the reflector to seal the first gel, the transparent shroud being combined with the reflector to form one body; and
a fluorescent gel layer provided between the transparent shroud and the first gel, the fluorescent gel layer being provided therein with a fluorescent powder and a second gel, the fluorescent powder being covered within the second gel.

2. The lamp according to claim 1, wherein the reflector has a base, a first reflecting portion and a second reflecting portion, the opening is formed through the base for allowing a LED module to be received therein, the first reflecting portion and the second portion are formed by extending outwards from both sides of the base, the first reflecting portion and the second reflecting portion together define the accommodating space.

3. The lamp according to claim 2, wherein the second gel is transparent silica gel or oil ink, the fluorescent gel layer is formed on one end of the first gel adjacent to the transparent shroud.

4. The lamp according to claim 2, wherein the second gel is transparent silica gel or oil ink, the fluorescent gel layer is formed in the transparent shroud adjacent to the first gel.

5. The lamp according to claim 4, wherein a rugged surface is provided between the transparent shroud and the fluorescent gel layer, the rugged surface is formed on an outer surface of the fluorescent gel layer which is not brought into contact with the first gel.

6. The lamp according to claim 4, further comprising a lens connected to a bottom of the transparent shroud, wherein the lens covers one end of the first gel adjacent to the fluorescent gel layer, and another fluorescent powder is filled in the lens.

7. The lamp according to claim 4, further including at least one lens provided in the fluorescent gel layer, wherein the fluorescent gel layer is formed to cover outside the lens.

8. The lamp according to claim 1, wherein the transparent shroud is any one selected from a group including a glass lens, a convex lens, a concave lens, a Fresnel lens and a composite lens constituted of a plurality of lenses.

9. The lamp according to claim 7, wherein a contact area between the fluorescent gel layer and the lens is larger than or equal to an illuminated area of the transparent shroud.

10. The lamp according to claim 7, wherein a distance between the LED module and the fluorescent gel layer is larger than or equal to 2 mm.

11. The lamp according to claim 3, wherein the first gel is silica gel.

12. A LED module, including:
a substrate having an accommodating portion for allowing at least one LED chip to be received therein;
a reflector provided on the substrate to correspond to the LED chip, the reflector having an accommodating space in communication with the accommodating portion, a first gel being received in the accommodating space;
a transparent shroud connected to the reflector to seal the first gel, the transparent shroud being combined with the reflector to form one body; and
a fluorescent gel layer provided between the transparent shroud and the first gel, the fluorescent gel layer being provided therein with a fluorescent powder and a second gel, the fluorescent powder being covered within the second gel.

13. The LED module according to claim 12, wherein the reflector has a base, a first reflecting portion and a second reflecting portion, the base is connected to the substrate and the LED chip, the first reflecting portion and the second portion are formed by extending outwards from both sides of the base, the first reflecting portion and the second reflecting portion together define the accommodating space.

14. The LED module according to claim 13, wherein the second gel is transparent silica gel or oil ink, the fluorescent gel layer is formed on one end of the first gel adjacent to the transparent shroud.

15. The LED module according to claim 13, wherein the second gel is transparent silica gel or oil ink, the fluorescent gel layer is formed in the transparent shroud adjacent to the first gel.

16. The LED module according to claim 15, wherein a rugged surface is provided between the transparent shroud and the fluorescent gel layer, the rugged surface is formed on an outer surface of the fluorescent gel layer which is not brought into contact with the first gel.

17. The LED module according to claim 15, further comprising a lens connected to a bottom of the transparent shroud, wherein the lens covers one end of the first gel adjacent to the fluorescent gel layer, and another fluorescent powder is filled in the lens.

18. The LED module according to claim 15, further including at least one lens provided in the fluorescent gel layer, wherein the fluorescent gel layer is formed to cover outside the lens.

19. The LED module according to claim 12, wherein the transparent shroud is any one selected from a group including a glass lens, a convex lens, a concave lens, a Fresnel lens and a composite lens constituted of a plurality of lenses.

20. The LED module according to claim 12, wherein the substrate is made of a material selected from a group including copper, aluminum, ceramics, graphite and silicon.

21. The LED module according to claim 18, wherein a contact area between the fluorescent layer and a lens is larger than or equal to an illuminated area of the transparent shroud.

22. The LED module according to claim 18, wherein a distance between the LED module and the fluorescent gel layer is larger than or equal to 2 mm.

23. The LED module according to claim 14, wherein the first gel is silica gel.
